(19) United States
(12) Patent Application Publication
(10) Pub. No.: US 2025/0091735 A1
(43) Pub. Date: Mar. 20, 2025

(54) POURABLE AND DESTROYABLE SPACECRAFT MATERIAL AND COSMIC RAY RADIATION SHIELD

(71) Applicant: Wichita State University, Wichita, KS (US)

(72) Inventors: Nickolas Solomey, Wichita, KS (US); Jarred C. Novak, Wichita, KS (US)

(21) Appl. No.: 18/885,069

(22) Filed: Sep. 13, 2024

Related U.S. Application Data
(60) Provisional application No. 63/582,910, filed on Sep. 15, 2023.

(51) Int. Cl. B64G 1/54

(52) U.S. Cl. CPC B64G 1/546

(57) ABSTRACT

Spacecraft materials comprising a polymer and a shielding material are described. The spacecraft material may form a radiation shield, to shield a spacecraft from cosmic rays. In certain configurations, the spacecraft material may be poured onto, and cured, directly on the individual components of the spacecraft to form a radiation shield.

### REFERENCE TO RELATED APPLICATIONS

This patent application claims the benefit of U.S. Provisional Patent Application No. 63/582,910, filed Sep. 15, 2023, the entire disclosure of which is incorporated herein by reference.

### STATEMENT REGARDING FEDERALLY SPONSORED RESEARCH OR DEVELOPMENT

This invention was made with government support under NASA NIAC Grant Number 80NSSC21K1900 awarded by the National Aeronautics and Space Administration (NASA)/NASA Shared Services Center (NSSC). The government has certain rights in the invention.

### FIELD

Provided herein is a spacecraft material comprising a polymer and a shielding material. Also provided herein are methods for preparing the spacecraft material and a radiation shield comprising the spacecraft material. Still further, provided herein is a spacecraft comprising a spacecraft material comprising a polymer and a shielding material and methods for making said spacecraft.

### BACKGROUND

Historically, materials such as solid lead, solid steel, or solid iron have been used in spacecrafts to shield scientific detectors from cosmic rays when used in outer space. When returning the spacecraft to earth, the typical strategy is to have a controlled descent of the spacecraft, so as to avoid any unintended collisions on re-entry. Another strategy is to prepare a spacecraft with limited shielding, if any, such that it disintegrates on re-entry. Government space agencies generally require that all impacting parts of a spacecraft must impact the earth with no greater than 15 J of energy.

However, a problem is encountered where the design specifications for a spacecraft require significant shielding (e.g., for equipment on board), but do not allow for the possibility of a controlled descent upon re-entry. In this situation, typical shielding materials may not be suitable because they will not sufficiently degrade during an uncontrolled re-entry. That is, typical shield materials (i.e. solid lead) would result in the spacecraft impacting the earth at forces in excess of 15 J.

Therefore, there remains a need for improved spacecraft shielding materials. A particular need exists for shielding materials that provide sufficient protection from radiation while operating in space, but which significantly degrade upon re-entry so that an impact of less than 15 J can be achieved.

### SUMMARY

One embodiment of the present invention is directed to a spacecraft material. The spacecraft material comprises a polymer and a shielding material. The spacecraft material exhibits a less than 90% electron punch-through rate when subjected to about 1 GeV or less, about 500 MeV or less, about 400 MeV or less, about 300 MeV or less, about 200 MeV or less, about 100 MeV or less, about 75 MeV or less, about 50 MeV or less, about 25 MeV or less, about 20 MeV or less, about 18 MeV or less, about 16 MeV or less, about 14 MeV or less, about 12 MeV or less, or about 10 MeV or less of electron bombardment and/or a less than 90% proton punch-through rate when subjected to about 250 MeV or less, about 200 MeV or less, about 100 MeV or less, about 75 MeV or less, about 70 MeV or less, about 68 MeV or less, about 66 MeV or less, about 64 MeV or less, about 62 MeV or less, about 60 MeV or less, about 58 MeV or less, about 56 MeV or less, about 54 MeV or less, about 52 MeV or less, about 50 MeV or less, about 40 MeV or less, or about 30 MeV or less of proton bombardment.

Another embodiment of the present invention is directed to a method of preparing a spacecraft. The process comprises preparing a radiation shield comprising a spacecraft material and placing the radiation shield around the components of the spacecraft to form a spacecraft. The spacecraft material exhibits a less than 90% electron punch-through rate when subjected to about 1 GeV or less, about 500 MeV or less, about 400 MeV or less, about 300 MeV or less, about 200 MeV or less, about 100 MeV or less, about 75 MeV or less, about 50 MeV or less, about 25 MeV or less, about 20 MeV or less, about 18 MeV or less, about 16 MeV or less, about 14 MeV or less, about 12 MeV or less, or about 10 MeV or less of electron bombardment and/or a less than 90% proton punch-through rate when subjected to about 250 MeV or less, about 200 MeV or less, about 100 MeV or less, about 75 MeV or less, about 70 MeV or less, about 68 MeV or less, about 66 MeV or less, about 64 MeV or less, about 62 MeV or less, about 60 MeV or less, about 58 MeV or less, about 56 MeV or less, about 54 MeV or less, about 52 MeV or less, about 50 MeV or less, about 40 MeV or less, or about 30 MeV or less of proton bombardment.

A further embodiment of the present invention is directed to a method of preparing a spacecraft. The method comprises preparing a radiation shield mixture comprising the spacecraft material as described above; pouring the radiation shield mixture onto one or more components of a spacecraft; and curing the radiation shield mixture to form a radiation shield around the components and form the spacecraft.

Other objects and features will be in part apparent and in part pointed out hereinafter.

### BRIEF DESCRIPTION OF THE FIGURES

FIG. 1 reports the relationship between iron mass fraction and density of a spacecraft material.

FIG. 2 reports the relationship between tungsten mass fraction and density of a spacecraft material.

FIG. 3 reports the differences in theoretical and observed density for a given ratio of iron:epoxy in a spacecraft material.

FIG. 4 reports the differences in theoretical and observed density for a tall cylinder of spacecraft material.

FIG. 5 shows a mold (left) and a negative of the mold (right) used to form a spacecraft material.

FIG. 6 reports the electron punch-through rate of various materials.

FIG. 7 reports the proton punch-through rate of various materials.

FIG. 8 reports the results of particle bombardment of alpha particles and oxygen and iron nuclei against a 7.5 g/cm³ tungsten-doped epoxy.

FIG. 9 reports the differences in theoretical and observed density for an iron-doped epoxy.

### DETAILED DESCRIPTION

The present invention is directed to a spacecraft material comprising a polymer and a shielding material. In certain embodiments, the spacecraft material forms a shield (e.g., a radiation shield).

The term “spacecraft” as used herein is intended to refer to any craft, apparatus, satellite, device, etc. intended to be operated at least partially in low earth orbit (LEO), medium earth orbit (MEO), high earth orbit (HEO), or outer space generally. For example, “spacecraft” is intended to include geosynchronous satellites, LEO, MEO, and HEO satellites, space stations and components thereof, orbiting telescopes or other scientific equipment designed for operation in LEO, MEO, HEO or outer space.

Although a “shield” or “shielding” may be discussed herein as relating to radiation shielding, it will be understood that the spacecraft material may protect the spacecraft from other undesirable aspects of space. For example, the spacecraft material discussed herein may act as a radiation shield, a magnetic shield, an energy shield (i.e. against high energy particles), or as a shield against any other undesirable aspect of cosmic rays.

Spacecrafts intended to be returned to the earth's atmosphere are generally divided into two categories. Spacecrafts which can controllably re-enter the earth's atmosphere (e.g., to conduct a controlled landing or to ensure the craft lands in an uninhabited area—for example the ocean) and spacecrafts which are designed to fully or near-fully be destroyed during re-entry. For those intended to be destroyed during re-entry, government space agencies generally require that all parts of a spacecraft impact the earth with no greater than 15 J of energy. Therefore, these spacecrafts typically contain very small amounts of shielding, or no shielding at all.

A problem exits when a spacecraft is designed for operating in outer space for an extended period of time (e.g., more than one year, more than two years, etc.) and contains equipment which may be negatively impacted by the radiation, energy pulses, etc. experienced in outer space. For example, a spacecraft containing devices for neutrino detection. This type of spacecraft must be encased in adequate shielding, in order to protect the neutrino detection device(s) from external forces which may degrade the reliability or accuracy of the detection results (e.g., background noise produced by cosmic rays). However, traditionally known shielding materials that would be able to accomplish this task would not sufficiently be destroyed upon an uncontrolled re-entry into earth's atmosphere.

The inventors of the present disclosure surprisingly discovered a spacecraft material that not only provides adequate shielding when operating in outer space for an extended period of time (e.g., one year or greater), but which is sufficiently destroyed upon reentry to comply with government impact regulations.

The average re-entry temperature is approximately 1,871° C. This is above the melting point of iron (1,538° C.). However, other factors such as the size and speed of the object need to be considered when evaluating whether material would sufficiently be destroyed during re-entry. To accomplish the goal of shielding the desired neutrino detector, solid iron shielding would need to be no less than 1.5 cm thick. It was determined that upon re-entry a solid iron shield of this thickness would not be completely destroyed. It was also determined that there was a high probability of the iron shield impacting the earth at greater than 15 J of energy. Since the device was intended to have an uncontrolled re-entry, a solid iron shield would not be satisfactory.

There was also a need for materials that were lightweight yet structurally strong. Such a material would help ensure minimal movement during launch operations, while staying under the payload weight limit.

The inventors of the present disclosure discovered that a spacecraft material comprising a polymer and a shielding material as described herein could satisfy all of the required conditions. Additionally, the spacecraft material could be prepared to have a density sufficiently aligned with the density of pure iron such that adequate shielding could be achieved.

When selecting a polymer for the spacecraft material, it may be desirable to select a polymer that has a relatively long working life (e.g., at least 120 minutes). A long working life (i.e. before curing) allows for adequate mixing of the shielding material into the polymer prior to the polymer curing. It is also important that the conditions encountered in outer space are considered when selecting a polymer. For example, an overlap shear test may provide insight into the shear strength of a material, particularly when it is bonded directly to the spacecraft. The shear modulus and viscosity of the polymer may also be helpful for indicating the suitability of a polymer for the rigor of entering and surviving in outer space. For example, ejection out of a rocket and exposure in outer space to debris impacts and radiation.

In certain embodiments, the polymer of the present disclosure may be polyester resin. In other embodiments, the polymer may be an epoxy adhesive resin. Importantly, the epoxy resin must be able to withstand the conditions of outer space (i.e. be a “space-grade” epoxy resin). For example, the space-grade epoxy resin may be selected from the group consisting of bisphenol-based epoxy resin, novolak epoxy resin, aliphatic epoxy resin, halogenated epoxy resin, glycidyl-based epoxy resin, and combinations thereof. In one specific embodiment, the polymer may be 2216 translucent epoxy adhesive resin (commercially available from 3M, Inc.).

In certain embodiments, the polymer may have an overlap shear tests result of about 3,000 psi or greater, about 4,000 psi or greater, about 5,000 psi or greater, about 6,000 psi or greater, about 7,000 psi or greater, about 8,000 psi or greater, about 9,000 psi or greater, or about 10,000 psi or greater.

In some embodiments, the shear modulus of the polymer may be from about 200 MPa to about 4,000 MPa, from about 250 MPa to about 4,000 MPa, from about 300 MPa to about 4,000 MPa, from about 300 MPa to about 3,500 MPa, from about 300 MPa to about 3,000 MPa, or from about 350 MPa to about 2,750 MPa.

In other embodiments, the polymer may have a viscosity of from about 3,000 cPs to about 12,000 cPs, from about 3,500 cPs to about 12,000 cPs, from about 4,000 cPs to about 12,000 cPs, from about 4,500 cPs to about 12,000 cPs, from about 5,000 cPs to about 12,000 cPs, from about 5,000 cPs to about 11,000 cPs, from about 5,000 cPs to about 10,000 cPs, or from about 5,000 cPs to about 9,000 cPs. The viscosity of the polymer may be particularly important in embodiments wherein the spacecraft material is intended to be poured into a mold prior to curing, as described in further detail below.

As described in further detail below, in certain embodiments, the shielding material and polymer a mixed to form a mixture. The mixture is formed into the desired shape or configuration. The mixture is then allowed to cure and form the final spacecraft material.

The spacecraft material comprises a shielding material. In certain embodiments, the shielding material is a metal or alloy. In other embodiments, the shielding material is selected from the group consisting of tungsten, iron, and combinations thereof. In one embodiment, the shielding material comprises iron. In another embodiment, the shielding comprises tungsten.

In certain embodiments, the shielding material may be present in the form of a powder. In other embodiments, the shielding may be present in the form of particles. In still a further embodiment, the shielding material may comprise a powder and particles.

In some embodiments wherein the shielding material is in the form of particles or comprises particles, the particle size may be from about 1 μm to about 1,000 μm, from about 1 μm to about 750 μm, from about 1 μm to about 500 μm, from about 1 μm to about 250 μm, from about 1 μm to about 200 μm, from about 1 μm to about 100 μm, from about 1 μm to about 95 μm, from about 1 μm to about 90 μm, from about 1 μm to about 85 μm, from about 1 μm to about 80 μm, from about 1 μm to about 75 μm, from about 1 μm to about 70 μm, from about 1 μm to about 65 μm, from about 1 μm to about 60 μm, from about 1 μm to about 55 μm, from about 1 μm to about 50 μm, from about 1 μm to about 45 μm, from about 1 μm to about 40 μm, from about 1 μm to about 35 μm, from about 1 μm to about 30 μm, from about 1 μm to about 25 μm, from about 1 μm to about 20 μm, from about 1 μm to about 15 μm, or from about 1 μm to about 10 μm.

In embodiments wherein the shielding material is in the form of a powder or particles, it will generally be understood that the shielding material is present throughout the spacecraft material. That is, when mixed with the polymer, it may be desirable to avoid large masses of shielding material in localized locations. A more even distribution of the shielding material in the mixture (and ultimate spacecraft material) is believed to contribute to improved shielding results.

In some embodiments, it may be desirable to prepare the spacecraft material such that the individual components of the shielding material (e.g., each particle) do not touch each other when present within the polymer of the spacecraft material. That is, it may be desirable to maximize the distribution of the shielding material throughout the spacecraft material to the greatest extent possible. For example, in certain embodiments, the shielding material may be present in the spacecraft material in a concentration of about 7.5 g/cm³ or less. For example, in certain embodiments, from about 0.05 g/cm³ to about 7.5 g/cm³, from about 0.075 g/cm³ to about 7.5 g/cm³, from about 0.1 g/cm³ to about 7.5 g/cm³, from about 0.2 g/cm³ to about 7.5 g/cm³, from about 0.3 g/cm³ to about 7.5 g/cm³, from about 0.4 g/cm³ to about 7.5 g/cm³, from about 0.5 g/cm³ to about 7.5 g/cm³, from about 0.5 g/cm³ to about 7 g/cm³, from about 0.5 g/cm³ to about 6.5 g/cm³, from about 0.5 g/cm³ to about 6 g/cm³, from about 0.5 g/cm³ to about 5.5 g/cm³, from about 0.5 g/cm³ to about 5 g/cm³, from about 1 g/cm³ to about 5 g/cm³, from about 1 g/cm³ to about 4 g/cm³, from about 1 g/cm³ to about 3 g/cm³, or from about 1 g/cm³ to about 2 g/cm³.

In one embodiment, the spacecraft material comprises about 45 wt. % or less, about 40 wt. % or less, about 35 wt. % or less, about 30 wt. % or less, about 28 wt. % or less, about 26 wt. % or less, about 24 wt. % or less, about 22 wt. % or less, about 20 wt. % or less, about 18 wt. % or less, about 16 wt. % or less, about 14 wt. % or less, about 12 wt. % or less, about 10 wt. % or less, about 9 wt. % or less, about 8 wt. % or less, about 7 wt. % or less, about 6 wt. % or less, or about 5 wt. % or less of the shielding material. For example, from about 5 wt. % to about 45 wt. %, from about 5 wt. % to about 40 wt. %, from about 5 wt. % to about 35 wt. %, from about 5 wt. % to about 30 wt. %, from about 10 wt. % to about 30 wt. %, from about 15 wt. % to about 30 wt. %, or from about 20 wt. % to about 30 wt. %.

In another embodiment, the spacecraft material comprises about 50 vol. % or less, about 45 vol. % or less, about 40 vol. % or less, about 35 vol. % or less, about 30 vol. % or less, about 28 vol. % or less, about 26 vol. % or less, about 24 vol. % or less, about 22 vol. % or less, about 20 vol. % or less, about 18 vol. % or less, about 16 vol. % or less, about 14 vol. % or less, about 12 vol. % or less, about 10 vol. % or less, about 9 vol. % or less, about 8 vol. % or less, about 7 vol. % or less, about 6 vol. % or less, or about 5 vol. % or less of the shielding material. For example, from about 5 vol. % to about 50 vol. %, from about 10 vol. % to about 50 vol. %, from about 15 vol. % to about 50 vol. %, from about 20 vol. % to about 50 vol. %, from about 25 vol. % to about 50 vol. %, from about 25 vol. % to about 40 vol. %, or from about 25 vol. % to about 35 vol. %.

In certain embodiments, the spacecraft material has a density of from about 1 g/cm³ to about 10 g/cm³, from about 1 g/cm³ to about 9.5 g/cm³, from about 1 g/cm³ to about 9 g/cm³, from about 1 g/cm³ to about 8.5 g/cm³, from about 1 g/cm³ to about 8 g/cm³, from about 1 g/cm³ to about 7.5 g/cm³, from about 1.5 g/cm³ to about 7.5 g/cm³, from about 2 g/cm³ to about 7.5 g/cm³, from about 2.5 g/cm³ to about 7.5 g/cm³, from about 3 g/cm³ to about 7.5 g/cm³, from about 3.5 g/cm³ to about 7.5 g/cm³, from about 4 g/cm³ to about 7.5 g/cm³, from about 4.5 g/cm³ to about 7.5 g/cm³, or from about 5 g/cm³ to about 7.5 g/cm³.

It one embodiment of the present invention, it may be desirable to achieve a material having a density close to those traditionally used for shielding. For example, steel (8 g/cm³) or iron (7.8 g/cm³).

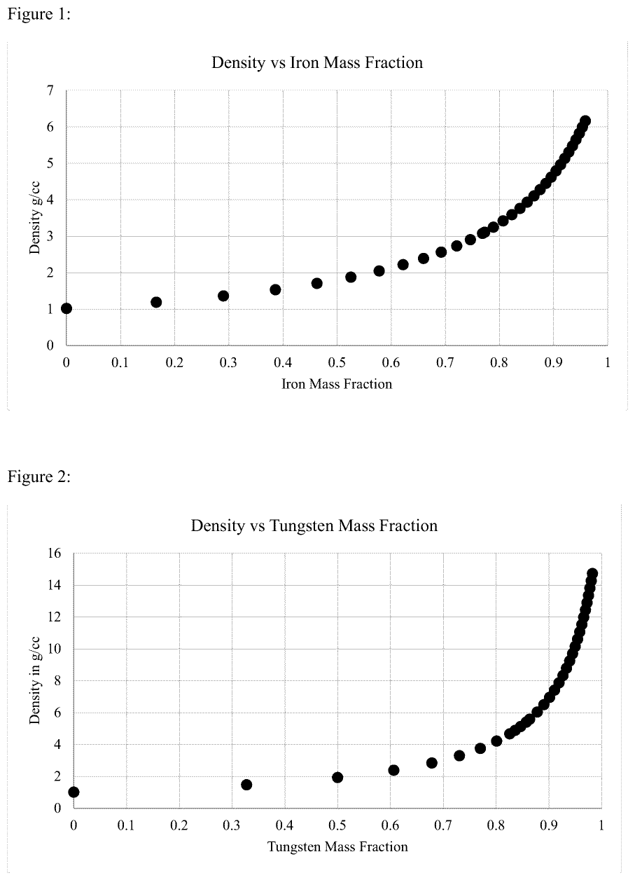

FIG. 1 and FIG. 2 show graphs demonstrating the relationship between shielding material concentration in the spacecraft material and density of the spacecraft material.

As described in further detail above, one aspect of the present invention is preparing a spacecraft material that balances the need for providing sufficient shielding, breaking down as the spacecraft material re-enters the earth's atmosphere, and minimizing the impact energy upon re-entry.

Radiation shielding efficacy may be approximated by conducting a test wherein electrons and/or protons are fired at the spacecraft material over a range of energy values. By conducting this test, it can be determined what percentage of the electrons and/or protons “punch-through” the spacecraft material and are observed on the other side. In certain embodiments described herein, the spacecraft material may be referred to as a “shield” when the material is used to shield another object.

In one embodiment, the spacecraft material does not exhibit discernible electron punch-through when subjected to about 20 MeV or less, about 18 MeV or less, about 16 MeV or less, about 14 MeV or less, about 12 MeV or less, about 10 MeV or less, about 9 MeV or less, about 8 MeV or less, about 7 MeV or less, about 6 MeV or less, about 5 MeV or less, about 4 MeV or less, about 3 MeV or less, about 2 MeV or less, about 1 MeV or less of electron bombardment. For example, from about 1 MeV to about 20 MeV, from about 1 MeV to about 18 MeV, from about 1 MeV to about 16 MeV, from about 1 MeV to about 14 MeV, from about 1 MeV to about 12 MeV, from about 1 MeV to about 10 MeV, from about 2 MeV to about 10 MeV, from about 3 MeV to about 10 MeV, from about 4 MeV to about 10 MeV, or from about 5 MeV to about 10 MeV.

In another embodiment, the spacecraft material does not exhibit discernible proton punch-through when subjected to about 200 MeV or less, about 175 MeV or less, about 150 MeV or less, about 125 MeV or less, about 100 MeV or less, about 75 MeV or less, about 70 MeV or less, about 68 MeV or less, about 66 MeV or less, about 64 MeV or less, about 62 MeV or less, about 60 MeV or less, about 58 MeV or less, about 56 MeV or less, about 54 MeV or less, about 52 MeV or less, about 50 MeV or less, about 40 MeV or less, or about 30 MeV or less of proton bombardment. For example, from about 20 MeV to about 200 MeV, from about 20 MeV to about 175 MeV, from about 20 MeV to about 150 MeV, from about 20 MeV to about 125 MeV, from about 20 MeV to about 100 MeV, from about 20 MeV to about 75 MeV, from about 20 MeV to about 70 MeV, or from about 20 MeV to about 60 MeV.

In certain situations, a 90% electron and/or proton punch-through rate (i.e. a 10% shielding rate) represents an acceptable level of shielding. It will be well understood that the acceptable level of shielding will depend upon the specific applications, including the sensitivity of the object being protected by the spacecraft material.

In one embodiment, the spacecraft material exhibits a less than 90% electron punch-through rate when subjected to about 1 GeV or less, about 500 MeV or less, about 400 MeV or less, about 300 MeV or less, about 200 MeV or less, about 100 MeV or less, about 75 MeV or less, about 50 MeV or less, about 25 MeV or less, about 20 MeV or less, about 18 MeV or less, about 16 MeV or less, about 14 MeV or less, about 12 MeV or less, or about 10 MeV or less of electron bombardment. For example, from about 10 MeV to about 1 GeV, from about 10 MeV to about 500 MeV, from about 10 MeV to about 400 MeV, from about 10 MeV to about 300 MeV, from about 10 MeV to about 200 MeV, from about 10 MeV to about 100 MeV, or from about 10 MeV to about 50 MeV.

In another embodiment, the spacecraft material exhibits a less than 90% proton punch-through rate when subjected to about 250 MeV or less, about 200 MeV or less, about 100 MeV or less, about 75 MeV or less, about 70 MeV or less, about 68 MeV or less, about 66 MeV or less, about 64 MeV or less, about 62 MeV or less, about 60 MeV or less, about 58 MeV or less, about 56 MeV or less, about 54 MeV or less, about 52 MeV or less, about 50 MeV or less, about 40 MeV or less, or about 30 MeV or less of proton bombardment. For example, from about 30 MeV to about 250 MeV, from about 30 MeV to about 200 MeV, from about 30 MeV to about 150 MeV, from about 30 MeV to about 100 MeV, from about 30 MeV to about 75 MeV, from about 30 MeV to about 70 MeV, from about 30 MeV to about 65 MeV, or from about 30 MeV to about 60 MeV.

In various embodiments, the spacecraft material is fully destroyed upon application of heat at a temperature of about 250° C. or greater, about 300° C. or greater, about 350° C. or greater, about 400° C. or greater, about 450° C. or greater, about 500° C. or greater, about 550° C. or greater, about 600° C. or greater, about 650° C. or greater, about 700° C. or greater, about 750° C. or greater, about 800° C. or greater, about 850° C. or greater, about 900° C. or greater, about 950° C. or greater, about 1,000° C. or greater, about 1,200° C. or greater, about 1,400° C. or greater, about 1,600° C. or greater, about 1,800° C. or greater, or about 2,000° C. or greater for a period of about 1 minute or greater, about 2 minutes or greater, about 3 minutes or greater, about 4 minutes or greater, about 5 minutes or greater, about 6 minutes or greater, about 7 minutes or greater, about 8 minutes or greater, about 9 minutes or greater, about 10 minutes or greater, about 15 minutes or greater, about 30 minutes or greater, or about 45 minutes or greater. For example, from about 250° C. to about 2,000° C., from about 250° C. to about 1,800° C., from about 250° C. to about 1,600° C., from about 250° C. to about 1,400° C., from about 250° C. to about 1,200° C., from about 250° C. to about 1,000° C., from about 250° C. to about 750° C., or from about 250° C. to about 500° C. for a period of about 1 minute or greater, about 2 minutes or greater, about 3 minutes or greater, about 4 minutes or greater, about 5 minutes or greater, about 6 minutes or greater, about 7 minutes or greater, about 8 minutes or greater, about 9 minutes or greater, about 10 minutes or greater, about 15 minutes or greater, about 30 minutes or greater, or about 45 minutes or greater.

In certain embodiments, the spacecraft material is fully destroyed upon application of heat at a temperature of from about 250° C. to about 1,000° C. for a period of about 5 minutes or greater. In other embodiments, the spacecraft material is fully destroyed upon application of heat at a temperature of about 750° C. for about 6 minutes or greater.

In other embodiments, upon re-entry into earth's atmosphere, the spacecraft material impacts the earth with less than about 15 J, less than about 14 J, less than about 13 J, less than about 12 J, less than about 11 J, less than about 10 J, less than about 9 J, less than about 8 J, less than about 7 J, less than about 6 J, less than about 5 J, less than about 4 J, less than about 3 J, less than about 2 J, or less than about 1 J of energy.

Certain spacecrafts navigate by reference to the earth's magnetic field. Conductivity of components other than those specifically required for navigation or operation of on-board equipment may negatively impact the ability of the spacecraft to reference the earth's magnetic field for navigation. Therefore, in some embodiments, the spacecraft material is non-conductive.

In other embodiments, the spacecraft material has an electrical conductivity at 20° C. of about 1.8×10⁷ S/m or less, about 1.7×10⁷ S/m or less, about 1.6×10⁷ S/m or less, about 1.5×10⁷ S/m or less, about 1.4 S/m or less, about 1.3×10⁷ S/m or less, about 1.2×10⁷ S/m or less, about 1.1×10⁷ S/m or less, about 1.0×10⁷ S/m or less, about 10×10⁶ S/m or less, about 8×10⁶ S/m or less, about 6×10⁶ S/m or less, about 4×10⁶ S/m or less, about 2×10⁶ S/m or less, or about 1×10⁶ S/m or less.

In further embodiments, the spacecraft material has an electrical conductivity at 20° C. of about 1,000 mho/m or less, about 900 mho/m or less, about 800 mho/m or less, about 700 mho/m or less, about 600 mho/m or less, about 500 mho/m or less, about 400 mho/m or less, about 300 mho/m or less, about 200 mho/m or less, about 100 mho/m or less, about 50 mho/m or less, about 40 mho/m or less, about 30 mho/m or less, about 20 mho/m or less, about 10 mho/m or less, about 5 mho/m or less, or about 1 mho/m or less.

In some embodiments, the spacecraft material may have no readily discernible impact on the magnetic field of the spacecraft (or spacecraft components) to which the material is applied. In one instance, the inventors used a hall effect sensor (i.e. hall probe) to detect the magnetic field generated by a cell phone. The cell phone was then placed fully within a shield comprising the spacecraft material and the magnetic field was again measured via a hall effect sensor. The results of this test indicated that the shield had no impact (discernible to the nanotesla (nT) level) on the magnetic field generated by the cell phone. Therefore, in certain embodiments, the spacecraft material has an impact on the magnetic field of the spacecraft (or spacecraft components) to which the material is applied of about 10 nT or less, about 5 nT or less, about 1 nT or less, about 0.5 nT or less, about 0.1 nT or less, about 0.05 nT or less, about 0.01 nT or less, about 0.005 nT or less, or about 0.001 nT or less.

Further aspects of the present disclosure are directed to methods of preparing the spacecraft material. In one embodiment, the shielding material is added to the polymer, the shielding material and the polymer are mixed to form a spacecraft material mixture, the spacecraft material mixture is poured into the desired mold or shape, and the spacecraft material mixture is then cured to form the spacecraft material. It has been discovered that the presence of air bubbles in the spacecraft material mixture can negatively impact the usefulness and distribution of shielding material within the final product. Therefore, in certain embodiments, steps may be taken to reduce or remove any air bubbles or air pockets in the spacecraft material mixture prior to curing.

In certain embodiments, air bubbles are reduced or removed by the use of vacuum pressure, physical compression, shaking, or combinations thereof. In other embodiments, the air bubbles are reduced or removed by pouring the spacecraft material mixture step-wise in one or more discrete steps, wherein after each pour methods selected from vacuum pressure, physical compression, shaking, or combinations thereof are used.

As noted above, the polymer may be selected such that the working life (e.g., before curing) is long enough to allow for the needed processing. For example, long enough to shape the spacecraft material mixture into the desired shape. While discussion herein is generally directed herein to shaping the spacecraft material mixture by using a mold, other methods of forming the spacecraft material mixture may be used. Depending on the properties of the polymer and spacecraft material mixture, the spacecraft material mixture may be extruded to form complex shapes. For example, using 3-D printing.

In certain embodiments, the spacecraft material is formed to have a thickness of about 5 cm or less, about 4.5 cm or less, about 4 cm or less, about 3.5 cm or less, about 3 cm or less, about 2.5 cm or less, about 2 cm or less, about 1.5 cm or less, or about 1 cm or less. For example, from about 0.5 cm to about 5 cm, from about 0.5 cm to about 4 cm, from about 0.5 cm to about 3 cm, from about 0.5 cm to about 2 cm, or from about 0.5 cm to about 1 cm.

Still further aspects of the present disclosure are directed to methods of preparing a spacecraft comprising the spacecraft material.

In one embodiment, the method of preparing the spacecraft comprises preparing a radiation shield comprising the spacecraft material and placing the radiation shield around a spacecraft. For example, the spacecraft material may be prepared as described above and molded into a desired shape to form a radiation shield. The components of the spacecraft (e.g., scientific equipment) may then be inserted into the shape such that the radiation shield encompasses the components and forms a spacecraft.

In another embodiment, the radiation shield is prepared by adding shielding material to a polymer, mixing the shielding material and the polymer to form a spacecraft material mixture, and pouring the spacecraft material mixture onto the exterior of the spacecraft component(s) or the portion(s) of the spacecraft that are desired to be shielded. The spacecraft material mixture may then be cured to form a radiation shield on the spacecraft. As discussed above with respect to the spacecraft material, the radiation shield may be generally non-conductive. Since this material is non-conductive, it can be poured directly onto electronic components without interfering with their operation. Further, pouring the spacecraft material mixture directly onto the components of the spacecraft allows for the preparation of a radiation shield that strictly conform to the shape of the spacecraft and minimizes the total size of the spacecraft. This may be particularly important when attempting to reduce the total volume of the package that is to be launched from a rocket to enter space.

An exemplary procedure for preparing a spacecraft material of the present invention is set forth below.
1. Start by calculating the desired density of the final spacecraft material.
2. Calculate the amount of polymer and shielding material that is needed to achieve desired density. This can be done with a mass fraction equation utilizing the densities of each individual component.
3. In a container, mix the shielding material particles. To the extent that the shielding material particles are present in different sizes, the mixing step should utilize equal parts of each size, with the goal of creating a homogeneous powder.
4. Prepare the polymer.
5. After the polymer is prepared, slowly start adding the mixed shielding material particles/powder.
6. After fully mixed, pour the mixture into a mold, only filling it about ⅕th full. Alternatively, the mixture can be poured directly onto the components.
7. Insert mold (or components having mixture poured directly thereon) into a low pressure vacuum chamber.
8. Cycle the chamber on and off until air pockets collapse.
9. Repeat steps 6-8 until mold is completely filled.
10. Secure mold (or components having mixture poured directly thereon) until it is completely cured to form the spacecraft material.

To improve results and accelerate the process, mix the shielding material and polymer within a vacuum chamber and also put the fully filled mold either in cold or heat chambers to reduce cure length.

By first preparing a homogeneous powder of shielding material particles, the shielding effect of the spacecraft material is likely to be more homogenous. Use of a homogenous powder also helps to ensure that the particles are suspended within the polymer and not stacking upon each other. The suspension is thought to be an important component of the radiation shielding for the spacecraft. It allows the spacecraft material mixture to be poured and formed around electronics (it does not interfere with magnetic fields) and poured into any shape or size that is needed for the desired application, without compromising the shielding ability of the spacecraft material. This process also gives a stronger structure overall.

### Embodiments

Certain embodiments of the present invention are set forth below.
Embodiment A1 is directed to a spacecraft material comprising:
   a polymer and a shielding material;
   wherein the spacecraft material exhibits a less than 90% electron punch-through rate when subjected to about 1 GeV or less, about 500 MeV or less, about 400 MeV or less, about 300 MeV or less, about 200 MeV or less, about 100 MeV or less, about 75 MeV or less, about 50 MeV or less, about 25 MeV or less, about 20 MeV or less, about 18 MeV or less, about 16 MeV or less, about 14 MeV or less, about 12 MeV or less, or about 10 MeV or less of electron bombardment; and/or
   wherein the spacecraft material exhibits a less than 90% proton punch-through rate when subjected to about 250 MeV or less, about 200 MeV or less, about 100 MeV or less, about 75 MeV or less, about 70 MeV or less, about 68 MeV or less, about 66 MeV or less, about 64 MeV or less, about 62 MeV or less, about 60 MeV or less, about 58 MeV or less, about 56 MeV or less, about 54 MeV or less, about 52 MeV or less, about 50 MeV or less, about 40 MeV or less, or about 30 MeV or less of proton bombardment.
Embodiment A2 is directed to the spacecraft material of Embodiment A1, wherein the polymer is a space-grade epoxy resin.
Embodiment A3 is directed to the spacecraft material of Embodiment A2, wherein the space-grade epoxy resin is selected from the group consisting of bisphenol-based epoxy resin, novolak epoxy resin, aliphatic epoxy resin, halogenated epoxy resin, glycidyl-based epoxy resin, and combinations thereof.
Embodiment A4 is directed to the spacecraft material of any one of Embodiments A1 to A3, wherein the shielding material is selected from the group consisting of tungsten, iron, and combinations thereof.
Embodiment A5 is directed to the spacecraft material of Embodiment A4, wherein the shielding material comprises tungsten.
Embodiment A6 is directed to the spacecraft material of Embodiment A4, wherein the shielding material comprises iron.
Embodiment A7 is directed to the spacecraft material of any one of Embodiments A1 to A6, wherein the shielding material is in the form of a powder.
Embodiment A8 is directed to the spacecraft material of any one of Embodiments A1 to A6, wherein the shielding material is in the form of particles.
Embodiment A9 is directed to the spacecraft material of any one of Embodiments A1 to A8, wherein the spacecraft material comprises about 30 wt. % or less, about 28 wt. % or less, about 26 wt. % or less, about 24 wt. % or less, about 22 wt. % or less, about 20 wt. % or less, about 18 wt. % or less, about 16 wt. % or less, about 14 wt. % or less, about 12 wt. % or less, about 10 wt. % or less, about 9 wt. % or less, about 8 wt. % or less, about 7 wt. % or less, about 6 wt. % or less, or about 5 wt. % or less of the shielding material.
Embodiment A10 is directed to the spacecraft material of any one of Embodiments A1 to A8, wherein the spacecraft material comprises about 50 vol. % or less, about 45 vol. % or less, about 40 vol. % or less, about 35 vol. % or less, about 30 vol. % or less, about 28 vol. % or less, about 26 vol. % or less, about 24 vol. % or less, about 22 vol. % or less, about 20 vol. % or less, about 18 vol. % or less, about 16 vol. % or less, about 14 vol. % or less, about 12 vol. % or less, about 10 vol. % or less, about 9 vol. % or less, about 8 vol. % or less, about 7 vol. % or less, about 6 vol. % or less, or about 5 vol. % or less of the shielding material.
Embodiment A11 is directed to the spacecraft material of any one of Embodiments A1 to A10, wherein the shielding material is present in the spacecraft material in a concentration of about 7.5 g/cm³ or less.
Embodiment A12 is directed to the spacecraft material of any one of Embodiments A1 to A11, wherein the spacecraft material has a density of about 10 g/cm³ or less, about 9 g/cm³ or less, about 8 g/cm³ or less, about 7 g/cm³ or less, about 6 g/cm³ or less, about 5 g/cm³ or less, about 4 g/cm³ or less, about 3 g/cm³ or less, about 2 g/cm³ or less, or about 1 g/cm³ or less.
Embodiment A13 is directed to the spacecraft material of any one of Embodiments A1 to A11, wherein the spacecraft material has a density of from about 1 g/cm³ to about 10 g/cm³, from about 1 g/cm³ to about 9.5 g/cm³, from about 1 g/cm³ to about 9 g/cm³, from about 1 g/cm³ to about 8.5 g/cm³, from about 1 g/cm³ to about 8 g/cm³, from about 1 g/cm³ to about 7.5 g/cm³, from about 1.5 g/cm³ to about 7.5 g/cm³, from about 2 g/cm³ to about 7.5 g/cm³, from about 2.5 g/cm³ to about 7.5 g/cm³, from about 3 g/cm³ to about 7.5 g/cm³, from about 3.5 g/cm³ to about 7.5 g/cm³, from about 4 g/cm³ to about 7.5 g/cm³, from about 4.5 g/cm³ to about 7.5 g/cm³, or from about 5 g/cm³ to about 7.5 g/cm³.
Embodiment A14 is directed to the spacecraft material of any one of Embodiments A1 to A13, wherein the spacecraft material is fully destroyed upon application of heat at a temperature of about 250° C. or greater, about 300° C. or greater, about 350° C. or greater, about 400° C. or greater, about 450° C. or greater, about 500° C. or greater, about 550° C. or greater, about 600° C. or greater, about 650° C. or greater, about 700° C. or greater, about 750° C. or greater, about 800° C. or greater, about 850° C. or greater, about 900° C. or greater, about 950° C. or greater, about 1,000° C. or greater, about 1,200° C. or greater, about 1,400° C. or greater, about 1,600° C. or greater, about 1,800° C. or greater, or about 2,000° C. or greater for a period of about 1 minute or greater, about 2 minutes or greater, about 3 minutes or greater, about 4 minutes or greater, about 5 minutes or greater, about 6 minutes or greater, about 7 minutes or greater, about 8 minutes or greater, about 9 minutes or greater, about 10 minutes or greater, about 15 minutes or greater, about 30 minutes or greater, or about 45 minutes or greater.
Embodiment A15 is directed to the spacecraft material of any one of Embodiments A1 to A14, wherein upon re-entry into earth's atmosphere the spacecraft material impacts the earth with less than about 15 J, less than about 14 J, less than about 13 J, less than about 12 J, less than about 11 J, less than about 10 J, less than about 9 J, less than about 8 J, less than about 7 J, less than about 6 J, less than about 5 J, less than about 4 J, less than about 3 J, less than about 2 J, or less than about 1 J of energy.
Embodiment A16 is directed to the spacecraft material of any one of Embodiments A1 to A15, wherein the spacecraft material is non-conductive.
Embodiment A17 is directed to the spacecraft material of any one of Embodiments A1 to A16, wherein the spacecraft material has an electrical conductivity at 20° C. of about 1.8×10⁷ S/m or less, about 1.7×10⁷ S/m or less, about 1.6×10⁷ S/m or less, about 1.5×10⁷ S/m or less, about 1.4 S/m or less, about 1.3×10⁷ S/m or less, about 1.2×10⁷ S/m or less, about 1.1×10⁷ S/m or less, about 1.0×10⁷ S/m or less, about 10×10⁶ S/m or less, about 8×10⁶ S/m or less, about 6×10⁶ S/m or less, about 4×10⁶ S/m or less, about 2×10⁶ S/m or less, or about 1×10⁶ S/m or less.
Embodiment A18 is directed to the spacecraft material of any one of Embodiments A1 to A17, wherein the spacecraft material has a magnetic field impact of about 10 nT or less, about 5 nT or less, about 1 nT or less, about 0.5 nT or less, about 0.1 nT or less, about 0.05 nT or less, about 0.01 nT or less, about 0.005 nT or less, or about 0.001 nT or less.
Embodiment A19 is directed to a spacecraft comprising the spacecraft material of any one of Embodiments A1 to A18.
Embodiment B1 is directed to a method of preparing a spacecraft, the method comprising:
   preparing a radiation shield comprising a spacecraft material, the spacecraft material comprising:
   a polymer and a shielding material
   wherein the spacecraft material exhibits a less than 90% electron punch-through rate when subjected to about 1 GeV or less, about 500 MeV or less, about 400 MeV or less, about 300 MeV or less, about 200 MeV or less, about 100 MeV or less, about 75 MeV or less, about 50 MeV or less, about 25 MeV or less, about 20 MeV or less, about 18 MeV or less, about 16 MeV or less, about 14 MeV or less, about 12 MeV or less, or about 10 MeV or less of electron bombardment; and/or
   wherein the spacecraft material exhibits a less than 90% proton punch-through rate when subjected to about 250 MeV or less, about 200 MeV or less, about 100 MeV or less, about 75 MeV or less, about 70 MeV or less, about 68 MeV or less, about 66 MeV or less, about 64 MeV or less, about 62 MeV or less, about 60 MeV or less, about 58 MeV or less, about 56 MeV or less, about 54 MeV or less, about 52 MeV or less, about 50 MeV or less, about 40 MeV or less, or about 30 MeV or less of proton bombardment; and placing the radiation shield around the components of the spacecraft to form a spacecraft.
Embodiment B2 is directed to the method of Embodiment B1, wherein preparing a radiation shield comprises: adding the shielding material to the polymer; mixing the shielding material and the polymer to form a spacecraft material mixture; pouring the spacecraft material mixture into a mold; and curing the spacecraft material mixture to form the radiation shield.
Embodiment B3 is directed to the method of Embodiment B1 or B2, wherein the radiation shield has a thickness of about 5 cm or less, about 4.5 cm or less, about 4 cm or less, about 3.5 cm or less, about 3 cm or less, about 2.5 cm or less, about 2 cm or less, about 1.5 cm or less, or about 1 cm or less.
Embodiment C1 is directed a method of preparing a spacecraft, the method comprising:
   preparing a radiation shield mixture comprising the spacecraft material of any one of Embodiments A1 to A19;
   pouring the radiation shield mixture onto one or more components of a spacecraft; and
   curing the radiation shield mixture to form a radiation shield around the components and form the spacecraft.
Embodiment C2 is directed to the method of Embodiment C1, wherein the radiation shield has a thickness of about 5 cm or less, about 4.5 cm or less, about 4 cm or less, about 3.5 cm or less, about 3 cm or less, about 2.5 cm or less, about 2 cm or less, about 1.5 cm or less, or about 1 cm or less.

### EXAMPLES

### Example 1

An experiment was conducted to prepare spacecraft material having different concentrations of shielding material, and by extension different densities.

A shielding material of iron was initially tested because iron does not become activated with exposure to radiation. Therefore, it was thought to be a suitable shielding material. Epoxy was used as the polymer for testing.

Small rectangular samples were prepared comprised of epoxy or iron-doped epoxy. The epoxy was a two-part resin that was mixed in equal amounts.

The total weight of epoxy was 10 g, to allow for testing of the ease of mixing of the iron filler and to test the pouring capabilities. Iron particles were added to the epoxy and mixed to give a ratio (on a mass basis) of parts iron per 1 part epoxy. The samples were mixed in small cylindrical plastic containers that were cut away after the resin fully cured.

The cure time for the epoxy was 7 days, with 30 days until the epoxy was fully hardened. To speed up the curing process, the samples were placed in a heating closet at a temperature of approximately 110° F.

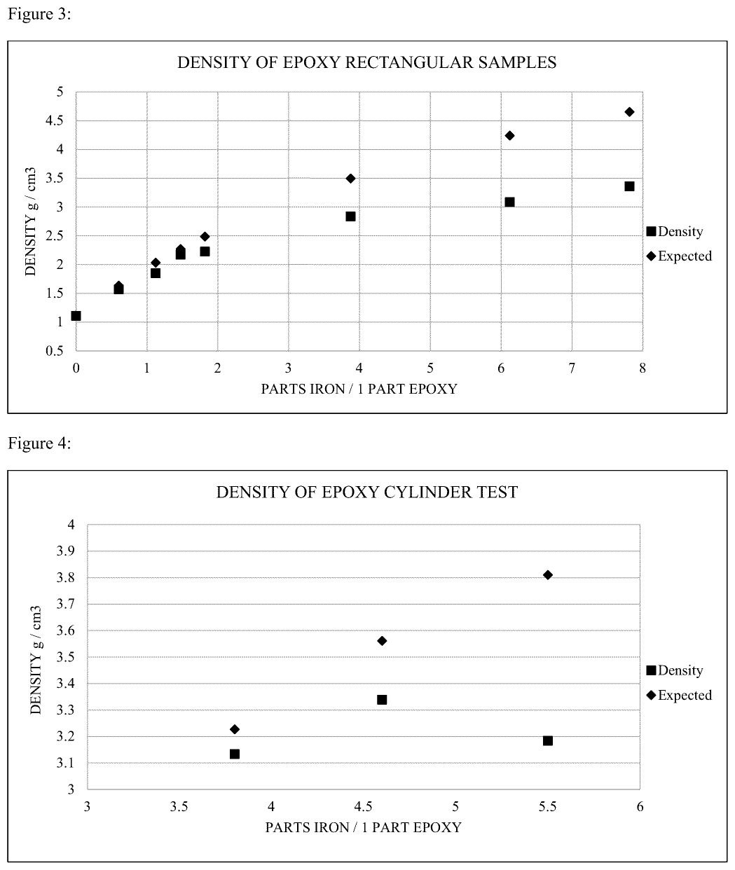

Once the samples were prepared and fully hardened, they were cut into rectangular samples. The density of each sample was then calculated by using a water displacement test in a graduated cylinder. For many of the samples, the measured density was different from the theoretical density. FIG. 3 reports the differences in density for a given ratio of iron:epoxy. It was determined that the discrepancy in theoretical versus experimental density was attributable to the presence of air bubbles within the iron-doped epoxy. This difference in density was more noticeable at higher densities. It is believed that the higher the density the more likely that air bubbles were contained within the iron-doped epoxy as a result of the mixing operation.

### Example 2

Next, a study was conducted to evaluate the density of iron-doped epoxy across the height of a sample. This test was important because the final spacecraft material was intended to be 12.5 cm tall. If the density was not homogeneous across the entire material, the shielding ability of the spacecraft material would be ineffective and create cosmic ray noise discrepancies in the measurement device encapsulated within the spacecraft material.

Iron-doped epoxy with target iron: epoxy mass ratios of approximately 1:4, 1:4.5, and 1:5.5 were prepared, poured into a graduated cylinder, and cured. The iron-doped epoxy was then cut into sections along the height of the sample and labeled numerically, with 1 corresponding to the base of the cylinder. Each sample was evaluated for density by using a water displacement test. Surprisingly, the densities of the samples contained minor discrepancies from the theoretical densities. Despite preparing samples having iron: epoxy mass ratios of 1:4, 1:4.5, and 1:5.5, the experimental testing indicated that the samples actually had an average iron: epoxy mass ratio of 1:3.765 (corresponding to a density of 3.133 g/cm³), 1:4.619 (corresponding to a density of 3.3383 g/cm³), and 1:5.425 (corresponding to a density of 3.183 g/cm³). The data corresponding to the sample prepared having an iron: epoxy mass ratio of 1:4 is reported below in Table 1. Cut #1 corresponds to the base layer of the cured cylinder and cut #12 corresponds to the top (highest) layer of the cured cylinder.

TABLE 1

| | | | | Iron Parts |
|---|---|---|---|---|
| Cut | Weight | Displacement | Density | Per 1 Part |
| # | (g) | (ml) | (g/cm³) | Epoxy |
| 1 | 7.7 | 2.5 | 3.08 | 3.765 |
| 2 | 8 | 2.75 | 2.91 | |
| 3 | 7.8 | 2.5 | 3.12 | |
| 4 | 7.9 | 2.75 | 2.87 | |
| 5 | 7.8 | 2.5 | 3.12 | |
| 6 | 7.2 | 2.25 | 3.2 | |
| 7 | 5.8 | 1.75 | 3.31 | |
| 8 | 6.9 | 2.25 | 3.07 | |
| 9 | 6.5 | 2 | 3.25 | |
| 10 | 7.1 | 2.25 | 3.16 | |
| 11 | 7.4 | 2.5 | 2.96 | |
| 12 | 3.9 | 1.1 | 3.55 | |

It was determined that the discrepancy in theoretical versus experimental density was attributable to the presence of air bubbles with the iron-doped epoxy.

Another test across multiple densities was conducted to evaluate the expected (theoretical) vs. observed density in an iron-doped epoxy prepared in a tall cylinder. As shown in FIG. 4, the expected (theoretical) vs. observed density was closer at lower densities. However, as the density increased, the presence of air bubbles appeared to be a larger issue.

### Example 3

An experiment was then conducted to evaluate procedures for removing air bubbles within the iron-doped epoxy (i.e. spacecraft material). Each sample consisted of a 1:8 ratio of epoxy to iron, with the only significant differences being the method in which the molds were filed, along with the mold material itself.

In a first sample, iron-doped epoxy was mixed in a metal container and poured into a thin cylindrical PETG mold. As expected, the density was less than what was calculated due to the formation of air bubbles. It proved to be difficult to remove from the mold due to adhesion to the PETG.

The second sample was prepared by compacting the iron-doped epoxy by hand within a glass container to try and reduce air pocket. The resulting material had fewer air bubbles then the first, but air bubbles were still visible once the material was removed from the container. This also proved difficult to extract from the mold. The material ultimately needed to be machined out.

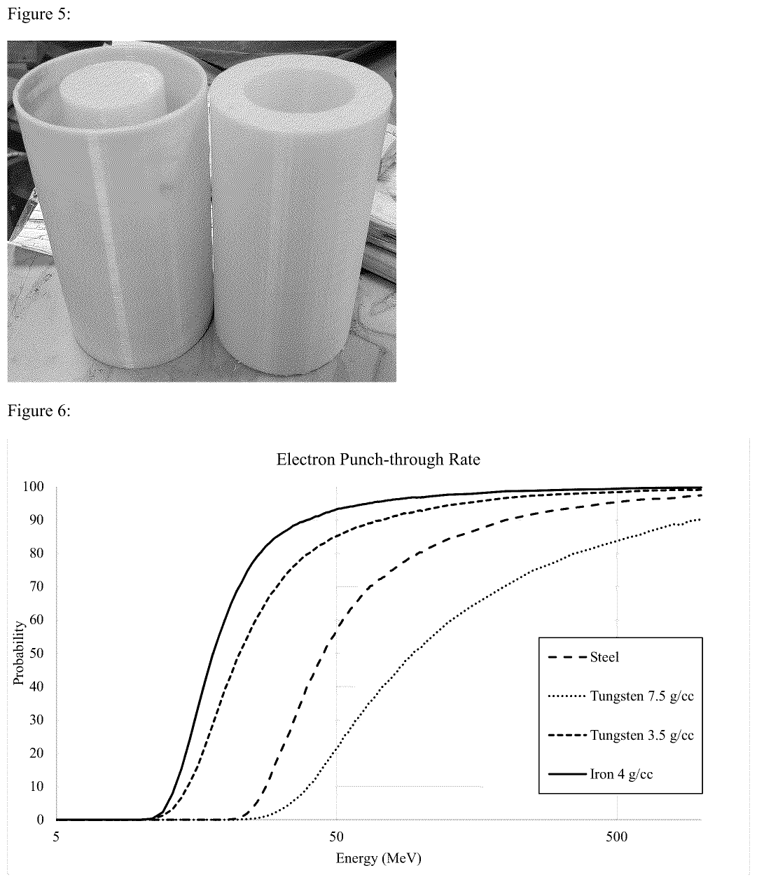

The third sample was made using a mold that was 3D printed. FIG. 5 shows the mold (left) and a negative of the mold (right). During the iron-doped epoxy pouring stage, the mold was filed a third of the way. Using the negative of the mold, the iron-doped epoxy was compacted. A vacuum chamber was then used to release the air bubbles. A low vacuum was applied until the iron-doped epoxy reached the top of the mold, then the pressure was quickly released to cause compression and remove air bubbles. This was repeated three times until the mold was complete filed. This method showed a significant decrease in the number of air bubbles.

A 3D printed mold of the required size and dimensions was then created, and the low vacuum compression technique was used. Less shielding material was needed to achieve the same density as compared to the first or second prototypes because the density was not reduced by the presence of air bubbles.

It was discovered that a silicon base mold allowed for removal of the spacecraft material, and also provided the benefit of being reusable.

### Example 4

After it was determined how to effectively make a spacecraft material having the air bubbles removed, an evaluation was done to determine the effectiveness of different shielding materials in the spacecraft material.

An iron-doped epoxy material was prepared having a density of 4 g/cm³, equating to 53% iron by volume. However, it was a goal of the experiment to obtain a spacecraft material having a density closer to that of steel (i.e. 8 g/cm³).

It was determined that the highest structurally stable density for an iron-doped epoxy shield was 4 g/cm³. It was discovered that an iron-doped epoxy having a density of 5 g/cm³ becomes supersaturated and never fully hardens. Therefore, it ultimately fails structurally. Further, as higher densities of iron-doped epoxy were tested, the mixture became concrete in nature and proved harder to pour and manipulate. The highest achievable mixture comprising an iron shielding material therefore was 4 g/cm³. This issue was not present with tungsten-doped epoxy prepared at the tested densities.

With tungsten having a higher density than iron, the ability to create a doped epoxy with a density similar to steel seemed more achievable. Samples of tungsten-doped epoxy were prepared having a density ranging from 3.5 g/cm³ to 7.5 g/cm³ and having a volumetric amount of from 10% to 40% tungsten.

Tungsten was determined to be a shielding material particularly suited for the desired application. The limitations of a tungsten-doped epoxy shield were confined to the payload weight, rather that the structural integrity of the shield itself. One potential issue with the use of tungsten is that after a period of approximately 2 years the metal will become activated by the constant radiation exposure. However, given the goal of the spacecraft material to provide shielding for periods of two years or less, the use of tungsten was particularly attractive.

### Example 5: Shielding Effectiveness

Several experiments were conducted to evaluate of the effectiveness of the spacecraft material to provide a shield from cosmic rays (e.g., radiation).

The goal of the spacecraft material was to stop most high energy particles up to about 50 MeV. Where the spacecraft material encompasses a neutrino detection device, it is not necessary to stop every energy particle below 50 MeV. However, for the detection device to operate properly and get the most accurate data, the majority of particles up to 50 MeV cannot be allowed to contact the device.

To evaluate the effectiveness of the spacecraft material, simulations were run at various densities of the spacecraft material and at various energy levels using Geant4. Geant4 is a C++ extension library for particle physics simulation. The simulations consisted of shooting electrons, protons, alpha particles, and oxygen and iron nuclei at a 1.5 cm thick doped epoxy (i.e. iron-doped epoxy or tungsten-doped epoxy as described above) at energy levels ranging from 1 MeV and up until a consistent failure rate was reached. An event was considered a failure if the particle punched through (i.e. if the particle or shower deposited any energy in the volume beyond the shield). A particularly important measurement was the percent of particles that passed through the shield at each energy level. The testing consisted of one million individual particle events and resulted in a statistical error of less than 0.1% at the 5-sigma level. A steel plate and non-doped epoxy were used as standards for reference.

The first test consisted of shooting both electrons and protons at energies ranging from 1 MeV to 1 GeV. These particles were fired at 1.5 cm thick spacecraft materials that consisted of iron-doped epoxy ranging in density from 2 g/cm³ to 5 g/cm³ or tungsten-doped epoxy ranging in density from 3.5 g/cm³ to 7.5 g/cm³.

At 2 g/cm³, the iron-doped epoxy had the ability to completely stop 6 MeV electrons and 52 MeV protons. Also at this density, a 90% punch-through rate (i.e. 90% of the electrons and/or protons penetrating the iron-doped epoxy) did not occur until 14 MeV for electrons and 54 MeV for protons. At 5 g/cm³, the iron-doped epoxy had the ability to completely stop electrons and protons at 12 MeV electrons and 94 MeV protons. A 90% punch-through rate did not occur until 28 MeV for electrons and 102 MeV for protons.

For tungsten-doped epoxy, the shielding ability was significantly higher than the iron-doped epoxy. At 3.5 g/cm³, the tungsten-doped epoxy had the ability to completely stop up to 12 MeV electrons and 60 MeV protons. A 90% punch-through rate did not occur until 74 MeV electrons and 64 MeV protons. At the higher density of 7.5 g/cm³, the tungsten-doped epoxy had the ability to completely stop up to 20 MeV electrons and 85 MeV protons. A 90% punch-through rate did not occur until 1 GeV electrons and 90 MeV protons.

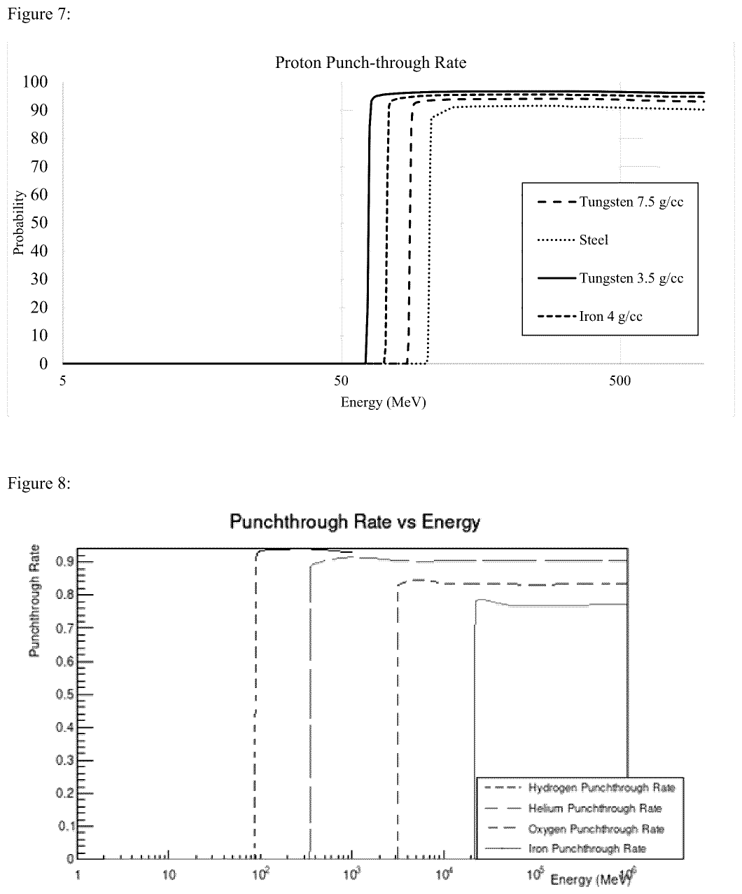

The results of the testing, as compared to a solid steel plate, are reported graphically in FIGS. 6 and 7. FIG. 6 reports the electron punch-through rate and FIG. 7 reports the proton punch-through rate.

These results, when compared to the standard of a solid steel plate, show that not only does the tungsten shield out-perform the iron shield, but also out-performs the solid steel shield in regards to electrons. These simulations show that it is possible to have cosmic ray radiation shielding that meets weight and re-entry requirements as well as the shielding requirements (i.e. a 10% reduction in cosmic ray noise-90% or less punch-through rate).

The simulations show an increase in stopping power as the spacecraft material trended towards the density of steel. Given the weight requirements for launching materials into space, this information gave insight into how to balance the weight and shielding requirements of each specific application.

### Example 6

A second set of simulations were run to evaluate how the materials would handle shielding of other particles such as alpha particles and oxygen and iron nuclei. The spacecraft material that was tested was a 7.5 g/cm³ tungsten-doped epoxy.

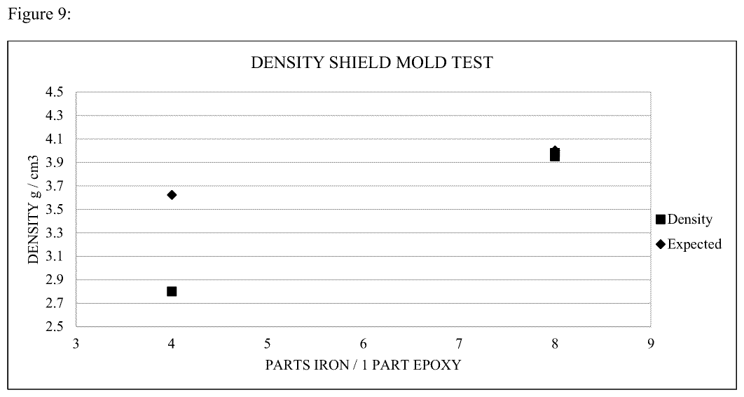

The results are reported in FIG. 8.

This study shows that at high energies the alpha particles tend to plateau at approximately 90% punch-through rate and that the nuclei never reach a 90% punch-through rate. Thus, even at high energies the tungsten-doped epoxy spacecraft material acts as an effective shield.

### Example 7

After completing the above experiments, final spacecraft materials were crafted. During this process four prototypes were created, three made of iron-doped epoxy and one made of tungsten-doped epoxy. The first iron prototype was found to have an actual density of 2.8 g/cm³, as compared to an expected density of 3.6 g/cm³. Therefore, the low vacuum technique described in Example 3 was used on the following two iron-doped epoxy prototypes. By operating using this technique, the actual densities corresponded more closely to the expected densities. These results are reported in FIG. 9.

A tungsten-doped epoxy spacecraft material was also crafted using the low vacuum technique. This resulted in a structurally strong spacecraft material with a density of 3.48 g/cm³ and an accuracy of 99.4% of the expected density value of 3.5 g/cm³.

The last requirement that needed to be tested was whether the spacecraft material would impact earth at more than 15 J after re-entering earth's atmosphere. To test this, small samples of the iron-doped epoxy spacecraft material and tungsten-doped epoxy spacecraft material were burned with a torch. The iron-doped epoxy sample started burning at approximately 260° C., with full destruction at 700° C. The tungsten-doped epoxy sample started burning at approximately 315° C., with full destruction at 424° C. Both of these samples burned well below the average re-entry temperature of 1800° C. Therefore, it is believed that this spacecraft material will be suitable for shielding when in outer space and destruction upon re-entry into the earth's atmosphere.

Having described the disclosure in detail, it will be apparent that modifications and variations are possible without departing from the scope of the disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above systems and methods without departing from the scope of the disclosure, it is intended that all matter contained in the above description and shown in the accompanying drawings shall be interpreted as illustrative and not in a limiting sense.

What is claimed is:

1. A spacecraft material comprising:
a polymer and a shielding material;
wherein the spacecraft material exhibits a less than 90% electron punch-through rate when subjected to about 1 GeV or less of electron bombardment; and/or
wherein the spacecraft material exhibits a less than 90% proton punch-through rate when subjected to about 250 MeV or less of proton bombardment.

2. The spacecraft material of claim 1, wherein the polymer is a space-grade epoxy resin selected from the group consisting of bisphenol-based epoxy resin, novolak epoxy resin, aliphatic epoxy resin, halogenated epoxy resin, glycidyl-based epoxy resin, and combinations thereof.

3. The spacecraft material of claim 1 wherein the shielding material is selected from the group consisting of tungsten, iron, and combinations thereof.

4. The spacecraft material of claim 3, wherein the shielding material comprises tungsten.

5. The spacecraft material of claim 3, wherein the shielding material comprises iron.

6. The spacecraft material of claim 1, wherein the shielding material is in the form of a powder, particles, or a combination thereof.

7. The spacecraft material of claim 1, wherein the spacecraft material comprises about 50 vol. % or less of the shielding material.

8. The spacecraft material of claim 1, wherein the shielding material is present in the spacecraft material in a concentration of about 7.5 g/cm³ or less.

9. The spacecraft material of claim 1, wherein the spacecraft material has a density of about 10 g/cm³ or less.

10. The spacecraft material of claim 1, wherein the spacecraft material is fully destroyed upon application of heat at a temperature of about 250° C. or greater for a period of about 1 minute or greater.

11. The spacecraft material of claim 1, wherein upon re-entry into earth's atmosphere the spacecraft material impacts the earth with less than about 15 J of energy.

12. The spacecraft material of claim 1, wherein the spacecraft material is non-conductive.

13. The spacecraft material of claim 1, wherein the spacecraft material has an electrical conductivity at 20° C. of about 1.8×10⁷ S/m or less.

14. The spacecraft material of claim 1, wherein the spacecraft material has a magnetic field impact of about 10 nT or less.

15. A spacecraft comprising the spacecraft material of claim 1.

16. A method of preparing a spacecraft, the method comprising:
preparing a radiation shield comprising a spacecraft material, the spacecraft material comprising:
a polymer and a shielding material;
wherein the spacecraft material exhibits a less than 90% electron punch-through rate when subjected to about 1 GeV or less of electron bombardment; and/or
wherein the spacecraft material exhibits a less than 90% proton punch-through rate when subjected to about 250 MeV or less of proton bombardment; and
placing the radiation shield around the components of the spacecraft to form a spacecraft.

17. The method of claim 16, wherein preparing a radiation shield comprises:
adding the shielding material to the polymer;
mixing the shielding material and the polymer to form a spacecraft material mixture;
pouring the spacecraft material mixture into a mold; and
curing the spacecraft material mixture to form the radiation shield.

18. The method of claim 16, wherein the radiation shield has a thickness of about 5 cm or less.

19. A method of preparing a spacecraft, the method comprising:
preparing a radiation shield mixture comprising the spacecraft material of claim 1;
pouring the radiation shield mixture onto one or more components of a spacecraft; and
curing the radiation shield mixture to form a radiation shield around the components and form the spacecraft.

20. The method of claim 19, wherein the radiation shield has a thickness of about 5 cm or less.
